(19) United States
(12) Patent Application Publication
(10) Pub. No.: US 2008/0225265 A1
(43) Pub. Date: Sep. 18, 2008

(54) METHOD AND APPARATUS FOR FINDING MACROMOLECULE CRYSTALLIZATION CONDITIONS

(75) Inventors: Marc L. Pusey, Huntsville, AL (US); Elizabeth L. Minamitani, Lacey's Spring, AL (US); Takahisa Minamitani, Lacey's Spring, AL (US)

Correspondence Address: JAMES RICHARDS, 58 BONING RD, FAYETTEVILLE, TN, 37334, US

(73) Assignee: MI Research, Inc., Huntsville, AL (US)

(21) Appl. No.: 11/725,114

(22) Filed: Mar. 17, 2007

(51) Int. Cl. G01N 21/01

(52) U.S. Cl. 356/30

(57) ABSTRACT

A system and method for determining macromolecule crystallization conditions by measuring the polarization anisotropy of a fluorescent probe attached to the macromolecule in solution as a function of a variation in crystallization conditions. In one exemplary embodiment, the concentration of the macromolecule material is varied and the polarization anisotropy as a function of concentration gives an indication of the proximity to crystallization conditions. A pulse illumination system with time gated detection is disclosed to isolate fluorescence response from excitation to reduce noise due to scattered and reflected light. A microassay system is disclosed to allow a complete 96 condition screen with less than 1 micro-liter of solution.

### BACKGROUND

1. Field of the Invention

The present invention pertains generally to the field of macromolecular characterization, and more particularly to the field of determining crystallization conditions related to a macromolecule.

2. Background of the Invention

Macromolecules include proteins, protein complexes, enzymes, nucleic acids, viruses, and generally any large complex molecule. Macromolecules find a wide range of applications, from pharmaceuticals to enzymes for medical diagnostic or industrial use. Macromolecules are almost always the targets for the development of new pharmaceuticals.

A critical step in the understanding of the function and operation of a particular macromolecule is to determine the macromolecular structure. Tools for determining structure, such as x-ray diffraction crystallography require a crystallized sample of the macromolecular material. The process for producing a crystallized sample typically involves obtaining a DNA sequence encoding the macromolecule, cloning and expression to generate a sufficient quantity of sample, purification to remove interfering substances, and finally crystallization. Since each of these steps is complex, only a limited number of targeted macromolecules, in particular, proteins reach the structure determination stage, and for those that do, only a very small sample of material may be available for analysis.

Crystallization of macromolecules is a delicate process requiring just the right concentration, compatible solution, and temperature. Macromolecule crystallization trials are typically carried out using a widely varying array of crystallization solutions, or ‘cocktails’, typically in blocks of 96 solutions at a time. The solutions are generated from a potential search space of dozens to hundreds of potential ingredients with a wide range of concentrations for each ingredient, together with pH and temperature variables. The number of permutations of solution definition characteristics is daunting. The results from these trials are then typically interpreted in a yes/no manner, i.e., crystal or no crystal. The data provides little guidance for subsequent trials unless a crystal is actually formed. Thus, many trials and/or macromolecule modifications at the chemical or genetic level may be required before the proper crystallization conditions are determined.

Thus, there is a need for a system and method for determining crystallization conditions of a macromolecular material that reduces the search space and potentially finds crystallization conditions rapidly, in a minimum number of trials, and needs only a small sample of the material.

### BRIEF DESCRIPTION OF THE INVENTION

Briefly, the present invention pertains to a system and method for determining macromolecule crystallization conditions by measuring the polarization anisotropy of a fluorescent probe attached to the macromolecule in solution as a function of a variation in crystallization conditions. In one exemplary embodiment, the concentration of the macromolecule material is varied and the polarization anisotropy as a function of concentration gives an indication of the proximity to crystallization conditions. A pulse illumination system with time gated detection is disclosed to isolate fluorescence response from excitation to reduce noise due to scattered and reflected light. A microassay system is disclosed to allow a complete 96 condition screen with less than 1 micro-liter of solution.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 shows a schematic diagram of the fluorescence anisotropy measurement of the macromolecule solution.

FIG. 2A and FIG. 2B show sample cases of anisotropy measurements for a series of solutions with varying concentration.

FIG. 3A-3D show examples of possible optical configurations.

FIG. 4A-FIG. 4C show the timing characteristics of excitation and fluorescence emission.

FIG. 5 shows the effects of solution viscosity and fluorescent probe lifetime on calculated anisotropy values as a function of the size of the rotating species.

FIG. 6 shows a range of postulated or potential concentration versus anisotropy curves.

FIG. 7 illustrates an exemplary automated measurement system in accordance with the present invention.

FIG. 8 is a block diagram of an exemplary algorithm to find crystallization conditions from an array of anisotropy measurement data.

FIG. 9 is a block diagram of an exemplary system for illuminating the sample and reading the fluorescent response.

FIGS. 10A through 10D show exemplary timing information for the system of FIG. 9.

### DETAILED DESCRIPTION OF THE INVENTION

Finding crystallization conditions for macromolecules is presently a tedious trial and error process where numerous cocktails of solvents, solutes, and the macromolecules are tested over a range of parameters such as concentration, temperature, and pH to find a set of conditions for crystallizing the macromolecule material. Success or failure is pinned on finding a crystal in a sample. The present invention streamlines the process by observing subtle changes in macromolecule solution properties that indicate a greater propensity to form a crystal. By observing these properties, a sample that does not yield a crystal and thus would yield a negative result in the conventional method may yield a measurement indicating a potential propensity for crystallization and thus point the way for further tests using related conditions to efficiently converge on the right conditions for crystallization.

### Overview

Crystallization is a self association process where the molecules sequentially arrange themselves in an orderly manner. For macromolecules, there is a narrow range of attractive interaction strengths, known as the crystallization slot (references 1, and 2), that favor the crystallization process. If the interaction forces are too strong, non crystalline precipitate is obtained. If the interaction forces are not strong enough, or are repulsive, then a clear solution is obtained.

In accordance with the present invention, the strength of interaction forces is determined by measuring the fluorescence anisotropy using a fluorescent tag (alternatively referred to as a probe) attached to the macromolecule. By observing changes in the interaction forces over a set of conditions, the more favorable crystallization conditions may be identified. In accordance with the present invention, a sample is illuminated with polarized light at the excitation wavelength of the tag and the polarization of the fluorescence is observed for an indication of the rotation rate of the molecule in solution. The illumination is absorbed most favorably in certain orientations of the molecule and the emission is related in polarization to the polarization of the absorbed illumination, but may be rotated as the molecule rotates in solution due to random thermal motion. The rotation rate in turn, will be influenced by molecule size and will be reduced as attraction forces between molecules increase and possible temporary molecule pairs may form. Thus, by observing the anisotropy of the polarization of the fluorescence emission, the average rotation rate may be observed, indicating the tendency to form crystals. To find conditions favorable for crystallization, the polarization anisotropy may be observed for a set of variable conditions and the most favorable conditions determined from evaluation of the observed rotation rates. Increasingly favorable conditions may be found by varying new conditions based on previously found most favorable conditions. Thus, useful information leading to finding crystallization conditions may be found from conditions that do not yet yield crystals—leading to the finding of crystallization conditions with many fewer trials.

By using pulsed illumination and time gating of the fluorescence signal scattered light from the illumination can be eliminated. This scattered light can be responsible for a considerable amount of random variability or noise in the fluorescence signal. Since the fluorescence is orders of magnitude less than the illumination, the scattered light from the illumination is difficult to eliminate by filters alone. Time gating allows for elimination of the illumination response. The time gating thus allows for greater toleration of contamination which, along with other higher molecular weight species present such as some precipitants, is responsible for scattered light and allows for smaller test volumes due to the improved signal to noise which allows use of a reduced fluorescence signal from the smaller volume.

In a further benefit, the technique is relatively insensitive to absorption from contaminants and other sources. The anisotropy measurement is a ratiometric measurement, depending only on the ratio of two components of fluorescent emission and is independent of the incident intensity. Thus, variation in factors such as the source intensity, or absorption by components or contaminants in the solution will have minimal effect on the anisotropy measurement.

Traditional methods for measuring the strength of interaction for crystallization conditions typically use light scattering (reference 1) and self-interaction chromatography (references 2 and 3). These methods are not well suited for making a large number of measurements on a small volume of solution. The light scattering method, in particular, is highly susceptible to noise and interference from other large molecules in the solution. Self interaction chromatography suffers from having to prepare a column matrix with covalently attached protein, having to then pour and calibrate the analytical column, and having to reequilibrate the column with each test precipitant solution of interest.

### DETAILED DESCRIPTION OF THE PREFERRED EMBODIMENTS

Prior to the measurements, proteins need to be prepared properly. The protein is covalently labeled with a suitable fluorescent probe, using methods well known to those familiar with protein modification chemistry. The preferable sites for labeling, in order, are the N-terminal amine, randomly labeled amine side chains, free sulfhydryl groups, and random carboxyl groups. Typical labeling procedures are provided in the literature or otherwise known in the art. Other sites may be labeled using the appropriate labeling chemistry and probes.

The labeling procedure typically involves:
1. Placing the macromolecule into an appropriate labeling buffer solution, using standard dialysis or other buffer exchange methods.
2. Determining the total number of protein molecules present, and then the target percentage to be labeled.
3. Adding the calculated amount of fluorescent probe, plus other components as necessary to carry out the reaction.
4. Allowing the reaction to proceed for the appropriate time.
5. Stopping the reaction.
6. Removing the unreacted probe from the labeled protein, using dialysis or size exclusion chromatography or other separation methods.
7. Concentrating the protein, determining the final protein and probe concentrations, and actual percentage of protein that was labeled.
8. At this point, if the percentage is determined to be too high, a calculated amount of unlabeled protein may be added to the labeled protein solution to adjust the percentage of labeled protein in solution.

The fluorescent probe concentrations in the assay should be between 10e-8 and 10e-6 M, with the fraction of protein molecules labeled typically being around 1%. This fraction is calculated based upon the protein's molecular weight and assumes a stock protein concentration for crystallization screening of 10 mg/ml.

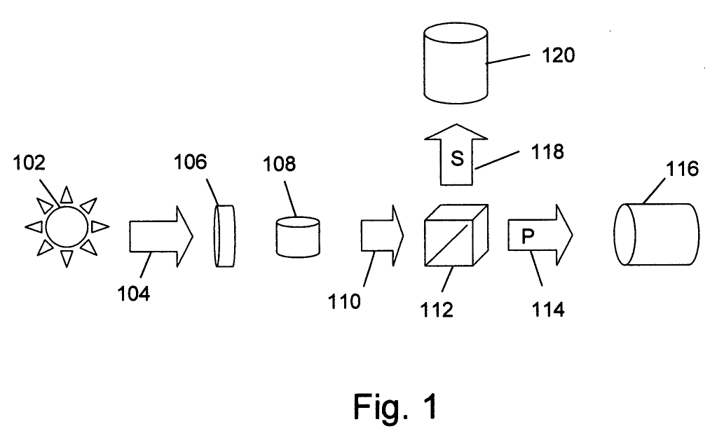

FIG. 1 shows a schematic diagram of the fluorescence anisotropy measurement of the macromolecule solution. Referring to FIG. 1, a light source 102, preferably a pulsed LED, generates a pulsed illumination 104 that is linearly polarized using a polarizer 106. The polarized illumination is partially absorbed by the fluorescent tag attached to macromolecules in the sample solution 108. The fluorescent tag emits 110 at a fluorescent wavelength that is typically different from the excitation wavelength. The emitted polarization is related to the excitation polarization according to the fundamental anisotropy of the tag and the time allowed for the molecule to rotate to a new position, shifting the polarization. The fluorescent emission is split into two components by a polarizing beam splitter 112. One component is polarized parallel to the incident excitation designated as “VV” 114. The other component is perpendicular to the incident excitation and is designated as “VH” 118. The intensities of these components may be designated I_{VV} and I_{VH} respectively. Each component is detected by a respective detector 116, 120. The detector may be preferably a photomultiplier tube, although other detector types may be used.

The anisotropy r is calculated with these intensity measurements as:

$$r = \frac{{I}_{vv} - {I}_{VH}}{{I}_{VV} + 2 {I}_{VH}} \qquad equation ( 1 )$$

where,

I_{VV} is the component parallel to the incident (excitation) illumination, and

I_{VH} is the component perpendicular to the incident illumination.

For one exemplary tag, the anisotropy value varies from 0.4 when the probe's absorption and emission polarization vectors are parallel, to −0.2 when the absorption and emission vectors are at a right angle. Since the anisotropy is a property of the structure of the fluorescing species other species may have different values.

Fundamental anisotropy, r₀, may be determined with the fluorescing species held stationary in a glass or frozen medium such that the molecules cannot rotate. When the molecules can freely rotate as in a liquid solution, the anisotropy is a function of time since excitation because of the rotation of the molecules due to random thermal motion. The anisotropy will be initially r₀ as measured in the glass medium, but will decay with time to zero (isotropic) as the molecules randomize. Measured anisotropy is thus a function of the measurement time related to the rotation rate of the molecules.

The anisotropy is a function of rotational correlation time, Θ;

$$r = \frac{{r}_{0}}{1 + ( \frac{τ}{Θ} )} \qquad equation ( 2 )$$

where r₀ is the fundamental anisotropy of the fluorescing species, and τ is the fluorescence life time (time to 1/e intensity, where e is the natural logarithm base). The rotational correlation time is, in turn, a function of molecular weight, M, of the macromolecule or macromolecule assembly as.

$$Θ = \frac{η M}{RT} ( \overline{v} + h ) \qquad equation ( 3 )$$

where η is the viscosity of the solution, R is the ideal gas constant, T is the absolute temperature, v is the specific volume of the macromolecule, and h is the hydration. For a given screening solution all parameters in the equation 3 but M typically stay constant. Note that hydration may reduce as water is lost at molecular contact sites, but the amount should be a relatively small change. Also, when comparing solutions of different viscosities, note that in equation 3, a change in η has the same effect on Θ as a proportionally equivalent change in M, thus it is important to account for solution viscosity when estimating changes in M by anisotropy measurements. In some cases, temperature, T, may be varied to determine optimum temperatures for crystallization.

Thus, in the typical solution, the increase of M is an indication of the macromolecule self associating, with the rate of increase of anisotropy as a function of the concentration in a given solution being characteristic of the form of self association, i.e., structured or non-structured, crystal or non-crystal.

$$M ∝ Θ = \frac{τ}{( \frac{{r}_{0}}{r} - 1 )} \qquad equation ( 4 )$$

This method enables us to measure increase of M by the increase of r. In other words, measuring anisotropy to monitor macromolecule self-association. In one embodiment, the fluorescent tag is selected to have a lifetime (decay time) commensurate with the rotation correlation time. Preferably, the rotation correlation time of a single molecule is shorter than the lifetime so that, as the mass increases by the association of two or more molecules, the anisotropy increases toward mid range and above.

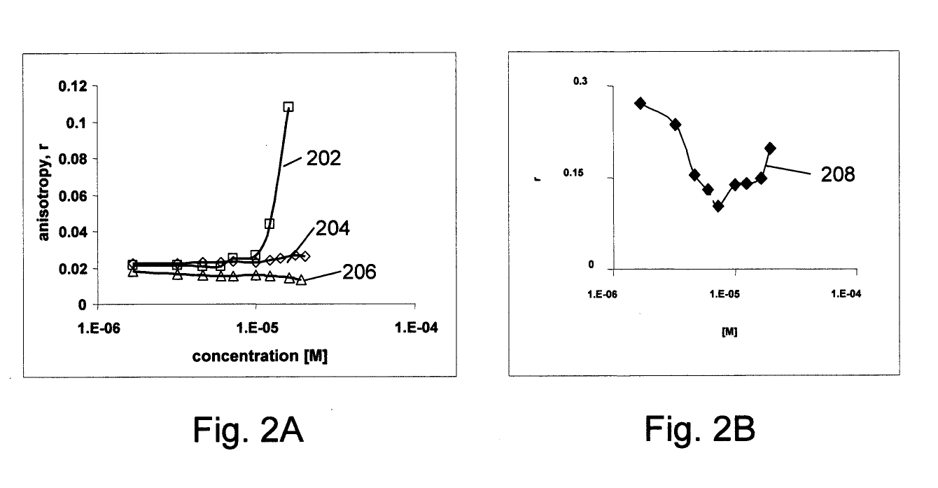

FIG. 2A and FIG. 2B show sample cases of anisotropy measurements for a series of solutions with varying concentration. Referring to FIG. 2A, the conditions of line 202 lead easily to crystallization. Line 202 is a nearly ideal result. Note the trend upward at the beginning and acceleration upward at mid graph. The conditions for line 204 also lead to crystallization, but with slight modification of the solution. Note the upward trend of the line 204 even though there is no acceleration upward within the test range. The conditions for line 206 did not lead to crystallization. Note the decreasing trend of the line with increasing concentration. The molecule remained in solution for this case. Referring to FIG. 2B, line 208 is shown with a different scale. Note that the graph starts very high and then decreases and then increases again. The high starting value suggests a noncrystalline precipitate, which was found with this solution.

The shape of the plots may be observed to estimate the likelihood of crystallization. An ideal curve begins with low anisotropy and increases gradually and monotonically, although slight up and down variation due to measurement noise and experimental variation is tolerated. Experimental variation may arise from several sources including variation in solution preparation, variation in contamination or surface effects of the containers. Measurement noise may include any noise source in the illumination or detection process including timing variation and statistical noise in counting photons. Measurement noise and experimental variation may be determined from each experimental apparatus by observing variations in a large number of samples, especially non-trending samples. The inventors have observed 5% variation in one experimental apparatus, i.e. 5% of the anisotropy span from zero to r₀.

At some concentration level, the curve begins a rapid acceleration upward indicating a tendency to associate. In contrast, a high value for low concentrations suggests strong attraction forces that lead to noncrystalline or microcrystalline precipitate. Also a decrease with increasing concentration suggests a solution that will not crystallize.

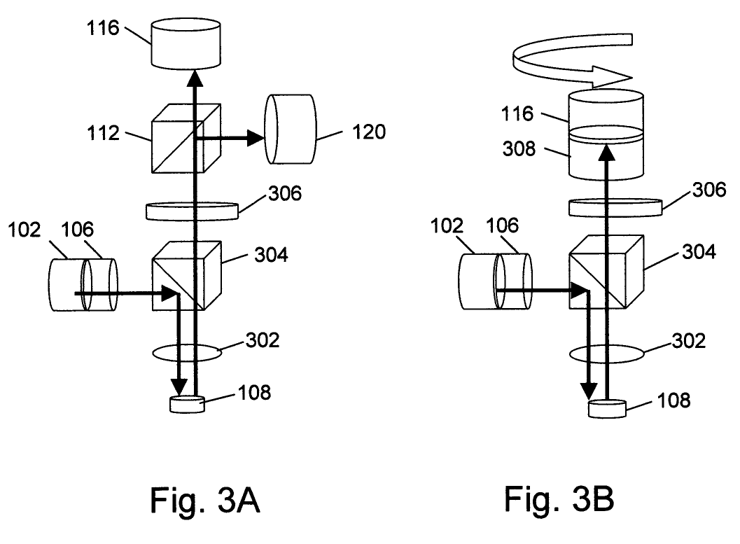

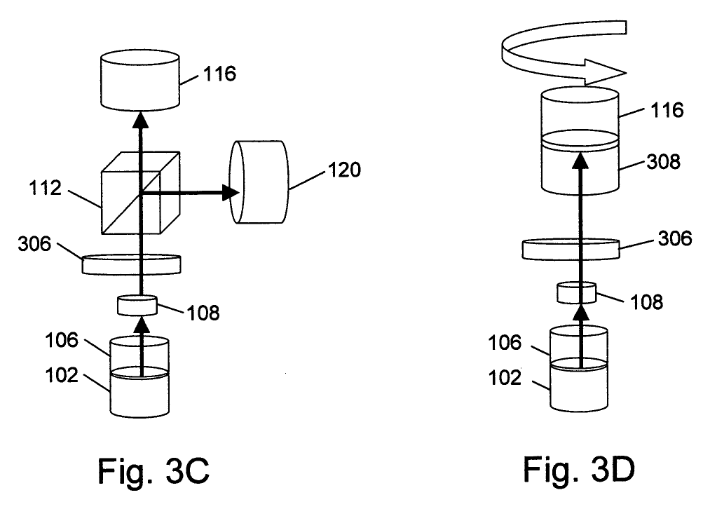

FIG. 3A-3D show examples of possible optical configurations. Referring to FIG. 3A, a light source 102 with polarizer 106 is directed to a dichroic mirror 304. The dichroic mirror reflects the light from the light source 102 and directs the light through condensing optics 302 to a sample solution 108 containing the tagged macromolecules. The light excites the fluorescent tag and a portion of the fluorescent emission returns through the condensing optics 302, now acting to image the fluorescent emission on a detector 116. The fluorescent emission passes through the dichroic mirror 304 without reflection because the fluorescent emission is at a different wavelength than the light source 102. The fluorescent emission then passes through a low pass filter 306 to further attenuate any remaining light from the light source 102. The fluorescent emission then passes through a polarizing beam splitter 112 to direct S and P polarized light to respective detectors 116 and 120.

Referring to FIG. 3B, the system is as shown in FIG. 3A with the polarizing beam splitter 112 and two detectors 116, 120 replaced with a single rotateable detector 116 and polarizer 308 assembly.

Referring to FIG. 3C, the system is configured to illuminate the sample from below in a pass through arrangement, eliminating the dichroic mirror 304 and condensing optics 302.

Referring to FIG. 3D, the system is the same as shown in FIG. 3C with the polarizing beam splitter 112 and two detectors 116, 120 replaced with a single rotateable detector 116 and polarizer 308 assembly.

The arrangement of FIG. 3A is a typical arrangement seen in most epifluorescence microscopes on the market. One advantage of this arrangement is compatibility with off-the-shelf optics and sensors and that no moving components are needed. However, since the light is split many times and the beam passes through many optical surfaces, the signal detected by the sensors could be greatly attenuated. The arrangement of FIG. 3B is simpler in terms of the number of detectors and could simplify calibration of the detector but introduces a moving part. The arrangement of FIG. 3C is further simplified by placing the light source 102 beneath the sample solution 108, eliminating the dichroic mirror 304. This could introduce direct noise from the light source in the line of sight. Proper choice of low-pass filter, combined with time gating of the data collection, should greatly reduce the noise. The arrangement of FIG. 3D is the simplest shown here by eliminating beam splitter and dichroic mirror. This configuration conserves the most light and could help reduce the required amount of solution.

The configurations of FIG. 3A-3D may be initially aligned by using a sample of the fluorescent tag in an immobilized state. The P and S (I_{VV} and I_{VH} respectively) emission polarization orientations may be determined as the rotations having the maximum and minimum respective response.

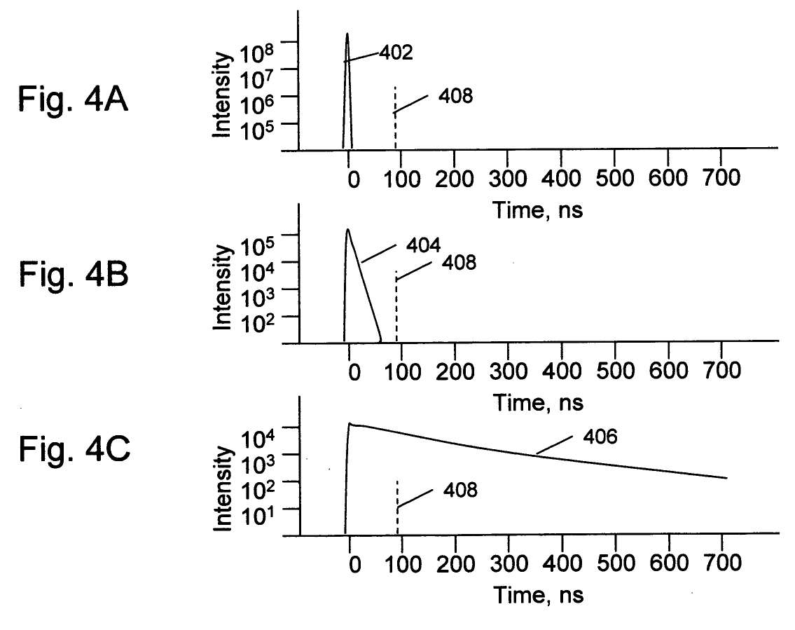

FIG. 4A- FIG. 4C depicts exemplary timing characteristics for excitation and fluorescence emission. FIG. 4A-FIG. 4C are shown on the same time scale for relative timing comparison. The data of FIGS. 4A-4C are notional and suggestive of typical performance, but not measured data. The intensity scale is shown in counts representing receiving photons in a photomultiplier tube.

Referring to FIG. 4A-4C, FIG. 4A illustrates an excitation pulse 402 The excitation pulse 402 may be on the order of four nanoseconds or longer, up to several hundred nanoseconds, in width. FIG. 4B illustrates an inherent fluorescent response 404 from a typical solution. The inherent response 404 may be due to the test material or impurities, but is not the response to be used for anisotropy measurement. The inherent response 404 may be brighter than the tag response 406 but is typically short lived (for example 10 ns lifetime). The inherent response 404 potentially disturbs the desired response 406 of the tag. In accordance with one embodiment of the invention, the inherent response 404 is essentially eliminated by starting accumulation of tag response 406 at a predetermined time 408 after the inherent response 404is substantially decayed, e.g. five to ten lifetimes. FIG. 4C illustrates the response 406 of the tag. It can be seen from the figure that the response 406 of the tag is only slightly decayed at the start time 408 for data accumulation.

The light source should be a monochromatic or narrow bandwidth short pulse. Both lasers and light emitting diodes are suitable for this requirement. Although lasers have narrower waveband and the beam is easier to be condensed, lasers are more expensive and more difficult to operate. Newer LED's may offer comparable performance with greater ease of use.

An exemplary LED is the Nichia NSPB300A, or LumiLED Superflux, or other high intensity LED having a relatively narrow emission angle and spectrum at the desired excitation wavelength.

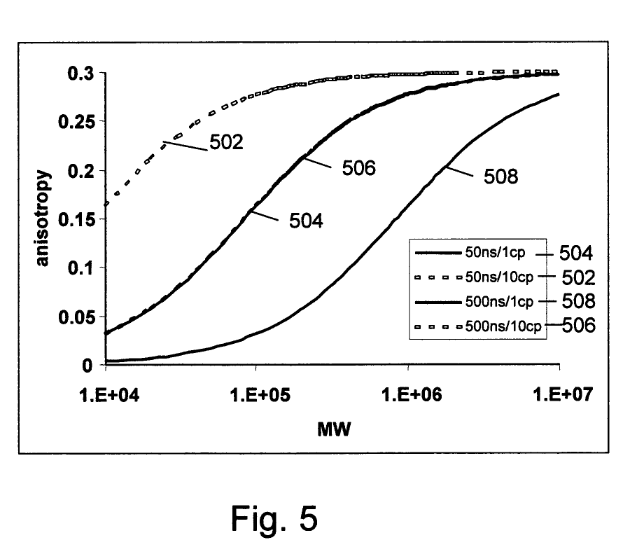

FIG. 5 shows the effects of solution viscosity on calculated anisotropy values. Fluorescence anisotropy is used to measure the rotational rate of the fluorescing species in solution. Interacting molecules will have an increase in their effective mass, and thus rotate more slowly, the parameter to be measured by this approach.

However, the rotational rate is also proportional to the solution viscosity. High viscosity precipitant solutions, such as those having 25% or 30% Polyethylene Glycol (PEG), will give higher anisotropy values even at low protein concentrations. In principle, the fluorescent probe should have a lifetime commensurate with the anticipated rotational rate of the molecule to be measured.

Referring to FIG. 5 comparison curves of anisotropy vs molecular weight are plotted for two fluorescent decay times (50 ns and 500 ns) and two viscosities (1 cp and 10 cp). The general trend of each curve can be observed from curve 508. Curve 508 is for the long time period and low viscosity, thus, it can be seen that for low molecular weight molecules the molecules will rotate rapidly and randomize the polarization resulting in near zero anisotropy. As the molecular weight increases, the molecules rotate more slowly, and the anisotropy approaches a limiting value, which is r₀, the value for stationary molecules. By comparison, curves 506 and 504 show increased viscosity and decreased fluorescence lifetimes, respectively. Note that a ten fold increase in viscosity has the same effect on anisotropy as a ten fold decrease in lifetime. Curve 502 illustrates the effect of a ten fold increase in viscosity compounded with a ten fold decrease in fluorescence lifetime. For low molecular weight analytes, increased viscosity results in a greater sensitivity to changes in mass.

When comparing solutions that have differing viscosities, the viscosity dependence can potentially cause confusion. For most proteins this would result in an increase in the measured anisotropy, and the data would appear to indicate that the protein is precipitating, that the conditions are not conducive to crystallization.

Use of very long lifetime probes also means that for smaller proteins there is very little change in anisotropy during the early stages of crystal nucleation. This problem can also be reconciled by recognizing that we are attempting, first and foremost, to eliminate conditions that lead to rapid precipitation from further consideration. By using fluorescent probes with very long lifetimes we can still collect data along the bottom of the anisotropy curve, i.e. begin with low concentrations at low anisotropy—nearly isotropic. Thus, mono dispersed protein molecules have plenty of time to randomize their positions before the data acquisition is completed. Dimerized and larger associations of molecules will be less random and show slightly elevated anisotropy values. Precipitated protein will have a large apparent mass, and thus have high anisotropy values (close to r₀) even at low concentrations. High viscosity solutions of mono dispersed protein will result in elevated anisotropy values, but these will be well below the limiting value (r₀) and, in the case of crystallization, still show an expected progressive rise with concentration if pre-crystalline self association is taking place. Low molecular weight mono dispersed solutions having low viscosity will also show a slight rise in anisotropy value with increasing concentration of the protein.

The fluorescence probes of choice are Metal Ligand Charge Transfer (MLCT) complexes, such as ruthenium bis(2,2′-bipyridine)-4,4′-dicarboxybipyridine (Ru(bpy)₂(dcbpy)). This probe has an excitation wavelength (Exₘₐₓ) peak at around 460 nm and an emission wavelength (Emₘₐₓ) peak at around 630 nm, the fluorescence lifetime σ is around 400 nano-seconds, and the fundamental anisotropy r₀ is 0.26 at 485 nm. Having a long lifetime, the fluorescence energy conversion is relatively inefficient. The fraction of light absorbed per mole, ε=14,500 M⁻¹, and the quantum yield is about 0.05. However, the large stokes shift (difference in wavelength between Exₘₐₓ and Emₘₐₓ) facilitates removal of the excitation from the emitted light by applying a low-pass filter, while the long lifetime enables removal of short lived noise (scattering and reflections of the excitation light, and any intrinsic fluorescence from the sample) by applying time gating. Other long lifetime fluorescent probes will also be suitable.

This probe (Ru(bpy)₂(dcbpy)) is commercially available as an amine-reactive activated disuccinimidyl ester. A number of other Ru-based probes may also be used. MLCT's based on Rhenium (Re) and Osmium (Os) have also been described [ref. 5]. The Re based probes typically have longer lifetimes, higher quantum yields, and blue-shifted excitation and emission spectra relative to Ruthenium (Ru) based probes, while the Os based complexes typically have shorter lifetimes and red shifted spectra. The Re complexes in particular are often oxygen sensitive, but this sensitivity typically decreases due to shielding upon conjugation to a protein. [Ru(bpy)2(dcbpy)] typically shows good absorption of excitation energy below 500 nm with a peak around 450 nm. The absorption slightly improves when conjugated to Human Serum Albumin (HSA), and the peak shifts to around 460 nm.

The anisotropy may also be characterized as a function of the excitation wavelength and bonding state. When conjugated with HSA, the probe has good anisotropy from about 460 nm to 510 nm. Thus, a good excitation wavelength may be around 480 nm where the probe has a weak but usable absorption efficiency and gives good anisotropy.

The emission spectrum of [Ru(bpy)₂(dcbpy)] conjugated with HSA shows a peak around 650 nm with virtually no emission shorter than 550 nm. Note that the emission spectrum is well separated from the 480 nm excitation. Thus, a wavelength filter or dichroic mirror may be used to separate the excitation energy from fluorescence response energy.

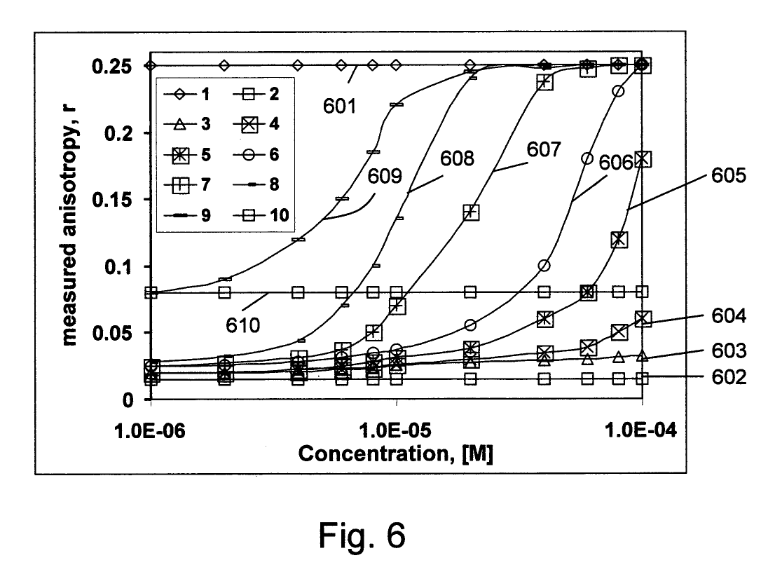

FIG. 6 shows a range of potential concentration versus anisotropy curves. Curve 601 would be a case where precipitation is occurring at the lowest protein concentrations, while curve 602 would be the result from a clear solution. Curve 603, which has a slight increase with concentration, would be indicative of crystallization conditions where the protein concentration needs to be increased. Curves 604 and 605 would be interpreted as being indicative of crystallization conditions, while we postulate that curve 606 would result in a microcrystalline precipitate.

Curves 607 through 609 are where additional crystallization conditions may be found that would not be recognized as such using current methods. In a standard screening methods where crystals are the desired endpoint, the outcomes at these conditions would likely be interpreted as either micro-granular or amorphous precipitate and considered to be failure. However, the low concentration anisotropy data indicates that the protein is showing a concentration-dependent self association. Therefore, we propose that if one can reduce the strength of the interactions the curves could be shifted to the right, such that they were more like curves 604 and 605. This can be brought about by reduction in the concentration(s) or composition of the precipitant solution components, and/or by the use of additives.

Additives are commonly employed in protein crystallization. Many additives act by increasing the solubility, which would have the effect of shifting the curves to the right. Testing for suitable additives can also be carried out using the anisotropy approach, and may not need a full titration curve, but only one data point. For example, if the “stock” condition gives anisotropy values at r₀ at, say 0.12× dilution, then addition of an additive and finding an anisotropy of, for example, 0.035, would suggest that the curve has been shifted to within the potential crystallization regime.

Curve 610 is postulated as the result that would be obtained in the case of a phase separation, where the protein is crowded due to partitioning, but does not undergo any further self association.

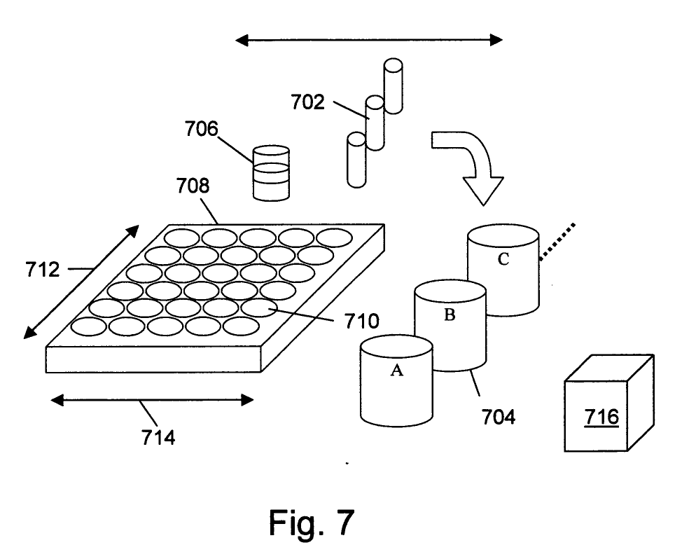

FIG. 7 illustrates an exemplary automated measurement system in accordance with the present invention. The system is capable of producing an array of solution samples of differing components and differing concentrations and then taking measurements on each sample automatically. Referring to FIG. 7, the system comprises two robotic systems under computer 716 control, one for dispensing the solutions and the other for moving the sample plate relative to the observing optics. The dispensing system comprises dispensing pipettes 702 which may access the solution reservoirs 704and then distribute a precise amount to each location 710 on the sample tray 708. The dispensing system may distribute nano-liter samples of macromolecule, buffer, and a number of crystallization solutions in precise amounts. An inkjet-type piezo-electric nozzle may be used for distributing very small samples. Inkjet systems may potentially distribute 20 pico-liter droplets.

The sample tray 109 is located on an X-Y stage for precise movement in X 714 and Y 712 directions. The movement of the tray 708 and sample distribution heads 702 has to be accurate enough to locate the drops onto the same spots 710 for proper mixing. Accuracy of a few microns may be necessary for the smallest samples. Mixing is by diffusion over the short distances of the 1 to 10 nanoliter volume drops. The sample array may then be moved to the measurement optics 706 and the tray 708 moved to each sample 710 in turn as data is collected. In an alternative embodiment, the optics 706 may move and the tray 708 may remain stationary.

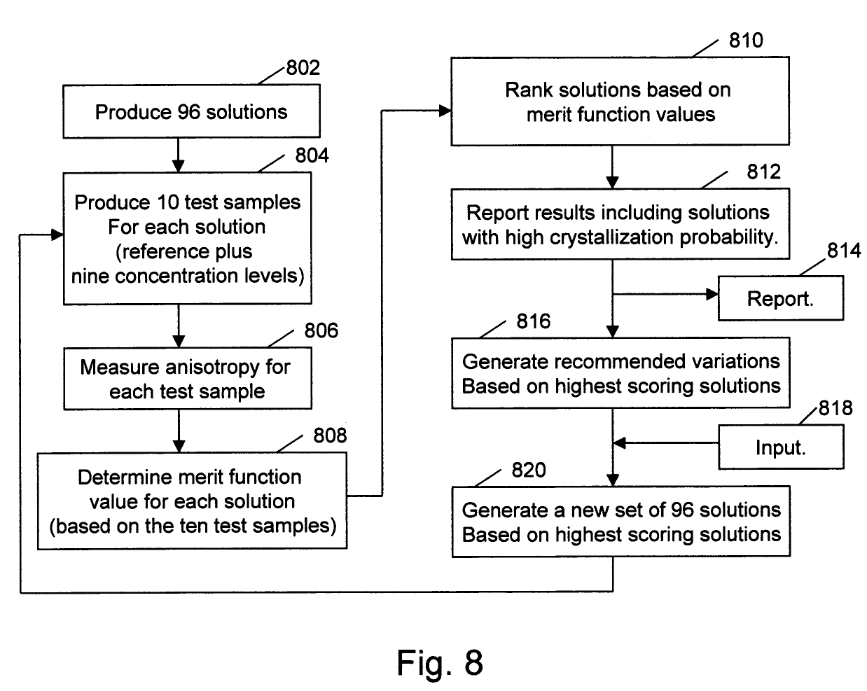

FIG. 8 is a block diagram of an exemplary algorithm to find crystallization conditions from an array of anisotropy measurement data. In the method of FIG. 8, a test array is produced 802 having a number of different solutions, for example 96 solution reservoirs. For each solution, a set of, for example ten, samples is generated 804 with each sample having an increasing concentration of the test macromolecule. Each test sample is then evaluated 806 for anisotropy. Thus, for each solution, a trend graph may be obtained showing the polarization anisotropy measurement as a function of increasing concentration of the macromolecule. This trend may then be processed 808 using a merit function to give a likelihood score for each solution. The solutions are then ranked 810 according to the merit function values (likelihood scores), and the results are reported 812, 814. The findings of a high likelihood solution may end the process, or the process may proceed to further refine the high likelihood results. If no high likelihood results are found, then the highest scoring results may be used to generate 816 a new set of recommended solutions. The new set of recommended solutions may be derived by varying the specifications for the high scoring solutions by interpolation or extrapolation of one or more elements defining the solutions, or by rules derived from experience with similar molecules. The new set of recommended solutions may be computer generated, however, a human operator may provide input 818 to modify, add, or delete solutions at this point. The system may then generate 820 a new set of solutions and proceed to evaluate 804 the new set of solutions.

Merit function

The merit function may be based on one or more of the following:

1. the anisotropy value at the lowest sample concentration,

2. monotonically increasing anisotropy with concentration, and

3. goodness of least squares fit of defined ideal curves to the data.

The merit function calculates a weighted sum of multiple factors listed above. A preferred criterion may be based on curve fitting to a range of ideal curves. The ideal curves may be empirically determined from a number of control samples and compared with the data giving a mean square error, where zero mean square error would be a score of 100 and increasing mean square error would subtract from 100. In one embodiment, a parameter of the ideal curve may be varied to minimize the mean square error.

When comparing and ranking test results between and among different solutions, it will be desirable to correct for different viscosities as described with reference to FIG. 5 or correct for other parameters such as temperature to better equivalence the result from one solution to another.

For each solution tested, a merit function value will be determined. If the test finds a solution with a merit function value greater than a predefined threshold value, then the test is judged successful and the system reports the resulting conditions. If the test includes no solution with an acceptable merit function value, the test procedure may be repeated with a new set of solutions. If one or more solutions show promise, but do not show a clear indication of crystallization, then the repeated test may use variations on the promising solutions. The variations may include more or less of one or more ingredients, a slight shift in pH, a slight shift in temperature, addition or subtraction of an additive or other variation. Based on the results of the variations, the specification for the solution may be further varied by extrapolation or interpolation. The results may include, but are not limited to the merit function, the trends observed, and whether precipitate or crystals were formed. Thus, through a logically developed sequence of informative iterative tests, the process may automatically follow a path to find a successful set of crystallization conditions. This iterative approach is not possible using conventional methods where the only result is whether a crystal is formed or not, with no quantitative likelihood result for the no-crystal case.

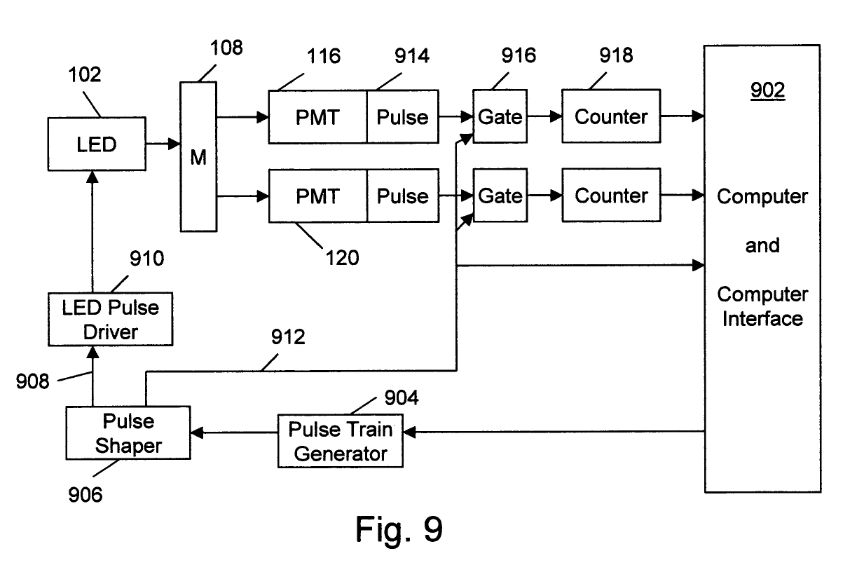

FIG. 9 is a block diagram of an exemplary system for illuminating the sample and reading the fluorescent response. The system sends a train of pulses to the LED light source 102 to excite the sample macromolecule solution 108 and counts fluorescent emission photons with two photomultiplier tubes (PMT) 116, 120, one for each polarization direction. A personal computer (PC) 902 is used to initiate the train of pulses and accumulate the result. Referring to FIG. 9, the PC 902 communicates with the system via a computer interface. The computer 902 sends a command to begin a pulse train to a pulse train generator 904. The pulse train generator 904 then generates a pulse train of a predetermined number of pulses, for example 1000 pulses. For each pulse from the pulse train generator, a pulse shaper generates a short pulse 908, for example 400 ns, to drive 910 the LED 102. The LED 102 illuminates the macromolecule sample 108 and excites the fluorescent tag. The two polarizations of fluorescent emission are received by the two PMT's 116, 120. Photon pulses are then detected from the PMT outputs and converted to digital pulse outputs 914. The pulse shaper 906 also generates a gating pulse 912 for counting PMT detections. A gate 916 allows pulses to be counted by a counter 918. The gating pulse 912 begins after the illumination pulse 908 ends and after a time interval allowing the LED response and any short time fluorescence from sources other than the tag to completely decay. The gate time 912 allows photon pulses to be counted in the counter 918 for a time interval, for example 1.5 microseconds. When the gate time is complete, the computer 902 is signaled to read the counter values.

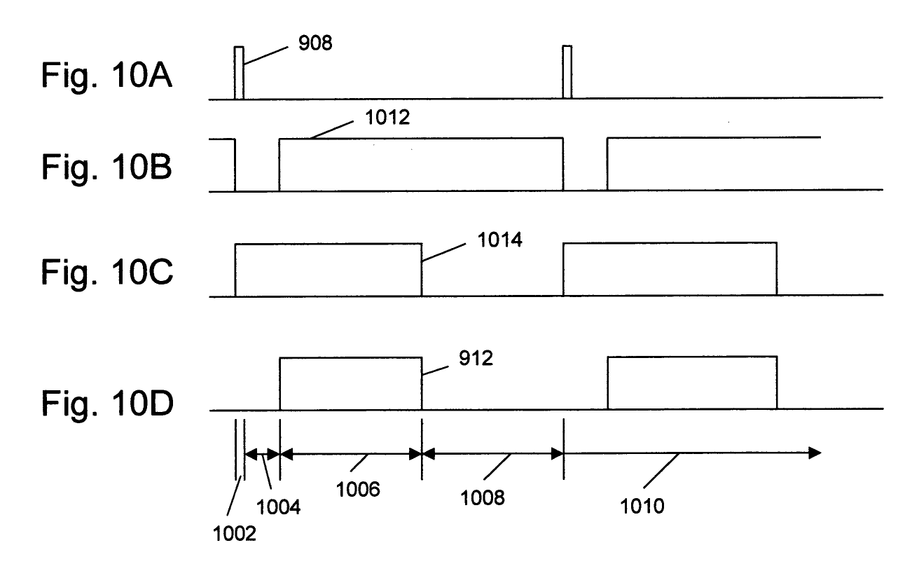

FIG. 10A through 10D show exemplary timing information for the system of FIG. 9. FIG. 10A through 10D use the same time scale shown with FIG. 10D. Referring to FIG. 10A through 10D, FIG. 10A shows an LED drive pulse train 908. FIG. 10D shows a gating pulse train 912. FIGS. 10B and 10C illustrate two waveforms used to derive the gating pulse of FIG. 10D. The pulses of FIG. 10A through 10C all start with the beginning of the LED pulse. The pulse 1012 of FIG. 10B is an inverted pulse with the beginning (falling) edge beginning with the beginning of the LED pulse. The ending (rising edge) of inverted pulse 1012 defines the time to begin accumulating PMT pulses. The pulse of FIG. 10B is anded with the pulse 1014 of FIG. 10C to derive the gating pulse 912 of FIG. 10D.

Each of the LED pulse train 908 and gating pulse train 912 may comprise any number of pulses desired to accumulate sufficient response for reliable detection, i.e., sufficient pulses to bring the detected signal above system noises to achieve the desired accuracy. The number may be for example 1000 pulses, but may be any number. Two pulses are shown. The time interval 1002 for the LED pulse may be for example 400 ns. The time 1004 after completion of the LED pulse and beginning of the gate time may be, for example 400 ns. The gate time 1006 may be for example 150 microseconds. The time 1008 to read the counter may be, for example 1 millisecond. The LED pulse is preferably on the same order or shorter than the fluorescence decay time. Longer times are less effective. The interval 1004 after the end of the LED pulse and the beginning of the PMT counting should preferably allow the LED response to fully decay and allow fluorescence from other than the tag to decay. The LED response depends on the LED selected. Typical unwanted fluorescence lifetimes will be on the order of 10 nanoseconds or less. Thus, eight to ten fluorescence lifetimes, for example, will substantially eliminate this source of noise and further improve the signal to noise ratio. The time 1006 to count the PMT pulses may be driven by energy considerations that suggest reading one or more lifetimes. Molecular rotation time considerations may suggest other time intervals. The time to read the counters 1008 is digital system dependent and may be essentially as fast as desired.

The system achieves extreme sensitivity by accumulating the response from many pulses over time, allowing a low excitation light intensity that does not disturb the solution conditions. Stray light from scattering and unwanted fluorescence is rejected by delaying the beginning of the pulse counting at a predefined time interval past the end of the excitation illumination. In a preferred embodiment this gate delay time and the data collection time are both adjustable, either through direct variation of a timing component or through a programmable setting of the timing intervals.

### Alternative Trend Conditions

This disclosure is written describing in detail the use of macromolecule concentration trends to evaluate the proximity to good crystallization conditions; however, other parameters that define the solution may also be used. Macromolecule concentration is the preferred variable because it is almost universally a one way trend. Other variables may decrease or have minima or maxima that result in a more complex analysis. However several of these other parameters, such as temperature or pH or concentration of a particular component may be varied and studied for appropriate results given the variable selected. A merit factor may be used that indicates an increase in likelihood of crystallization as particle mass increases as measured using polarization anisotropy.

In particular, temperature may be used as an alternative condition parameter to be varied. Temperature is particularly convenient in that entirely new solutions need not be produced for each step. A series of solutions may be generated by using a single solution that is run through a series of temperature steps to generate a set of anisotropy measurements. The set of measurements may then be evaluated for a trend in anisotropy indicating a trend in mass as a function of temperature. A monotonically increasing trend in mass for decreasing temperature may indicate good crystallization conditions.

### CONCLUSION

Thus, herein described is a system and method for determining crystallization conditions of a macromolecular material that reduces the search space and potentially finds crystallization conditions rapidly, in a minimum number of trials, and needs only a small sample of the material.

One should understand that numerous variations may be made by one skilled in the art based on the teachings herein. Such variations include but are not limited to different probes, timing, light sources, detectors, different variable conditions, such as pH, component concentration, temperature, and other factors.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the appended claims and their equivalents.

### REFERENCES

1. George, A. and Wilson, W. W. (1994). Predicting protein crystallization from a dilute solution property, Acta Cryst. D 50:361-365.
2. Garcia, C. D., Hadley, D. J., Wilson, W. W., and Henry, C. S. (2003), Measuring protein interactions by microchip self-interaction chromatography, Biotech. Prog. 19:1006-1010.
3. Tessier, P. M., Lenhoff, A. M., and Sandler, S. I. (2002), Rapid measurement of protein osmotic second virial coefficients by self-interaction chromatography, Biophys. J. 82:1620-1631.

What is claimed is:

1. A method for finding crystallization conditions for a macromolecule material comprising the steps of:
attaching a fluorescent tag to said macromolecule material;
preparing a first series of solutions including said macromolecule material, each of said solutions of said first series of solutions differing by a variable crystallization condition;
illuminating the first series of solutions with polarized light to excite said fluorescent tag to emit a fluorescent emission;
measuring the polarization anisotropy of the fluorescent emission from each solution of said first series of solutions to produce anisotropy measurements, said measuring within a predefined time interval after said illuminating; and
determining a crystallization likelihood merit factor based on a trend in said anisotropy measurements as a function of said variable crystallization condition.

2. The method according to claim 1, wherein the fluorescent tag comprises a metal ligand charge transfer complex.

3. The method according to claim 2, wherein the metal ligand charge transfer complex comprises ruthenium, rhenium, or osmium.

4. The method according to claim 3, wherein the metal ligand charge transfer complex comprises ruthenium bis(2,2′-bipyridine)-4,4′-dicarboxybipyridine.

5. The method according to claim 1, wherein the variable crystallization condition is a concentration of said macromolecule material.

6. The method according to claim 5, wherein the merit factor indicates an increase in likelihood when said trend is a substantially monotonically increasing trend in anisotropy with an increase in said concentration of said macromolecule material.

7. The method according to claim 1, wherein said polarized light is pulsed.

8. The method according to claim 7, wherein the predefined time interval begins after a prescribed delay from the end of the polarized light pulse.

9. The method according to claim 1, wherein the anisotropy measurements comprise a count of photon pulses from a photomultiplier tube.

10. The method according to claim 1, further including the step of determining, based on said merit factor, the specifications for a second series of solutions to be tested.

11. The method according to claim 10, further including the step of repeating the steps of claim 1 for the second series of solutions.

12. A system for finding a set of crystallization conditions comprising:
a first series of solutions of a molecular material for which said set of crystallization conditions is desired;
said molecular material tagged with a fluorescent tag having polarization anisotropic properties;
said first series of solutions varying from one solution to another in a selected condition from said set of crystallization conditions;
a polarization anisotropy measurement system comprising:
a polarized light source for exciting the fluorescent tag to produce a fluorescent response in said first series of solutions; and
an optical sensor system responsive to the fluorescent response from said fluorescent tag, said optical sensor system producing measurement values of the polarization anisotropy of the fluorescent response from said fluorescent tag from each solution of said first series of solutions; and
a processor, said processor generating a merit function value based on a trend in the polarization anisotropy measurement values as a function of said selected condition of said set of crystallization conditions.

13. The system according to claim 12, wherein said fluorescent tag comprises a metal ligand charge transfer complex.

14. The system according to claim 13, wherein the metal ligand charge transfer complex comprises ruthenium, rhenium, or osmium.

15. The system according to claim 14, wherein the metal ligand charge transfer complex comprises ruthenium bis(2,2′-bipyridine)-4,4′-dicarboxybipyridine.

16. The system according to claim 12, wherein said selected condition of said first set of crystallization conditions is concentration of said molecular material.

17. The system according to claim 12, wherein the merit function value shows an increase in likelihood of chrystallizaion for a substantially monotonically increasing trend in anisotropy with an increase in said concentration of said molecular material.

18. The system according to claim 12, wherein the polarized light source is pulsed.

19. The system according to claim 12, wherein the anisotropy measurement values comprise counting photon pulses from a photomultiplier tube.

20. The system according to claim 12, wherein the processor generates a specification for a second series of solutions for testing, said specification based on said merit function value.

21. The system according to claim 1, wherein the tag has a fluorescent lifetime longer than a rotational correlation time for said molecular material in a mono dispersed state.

22. The system according to claim 12, wherein said selected condition from said set of crystallization conditions is temperature.
